(19) United States
(12) Patent Application Publication
(10) Pub. No.: US 2008/0195508 A1
(43) Pub. Date: Aug. 14, 2008

(54) ENERGY FINANCIAL RECONCILIATION SYSTEM AND METHOD

(76) Inventors: Greg BAILEY, Burton, TX (US); Jason Lochhead, Frisco, TX (US)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(21) Appl. No.: 12/030,640

(22) Filed: Feb. 13, 2008

Related U.S. Application Data
(60) Provisional application No. 60/889,677, filed on Feb. 13, 2007.
(60) Provisional application No. 60/889,688, filed on Feb. 13, 2007.
(60) Provisional application No. 60/889,699, filed on Feb. 13, 2007.
(60) Provisional application No. 60/889,695, filed on Feb. 13, 2007.

(51) Int. Cl. G06Q 30/00; G06Q 10/00

(52) U.S. Cl. 705/27; 705/400

(57) ABSTRACT

An energy financial reconciliation method, comprising displaying at least two electricity options for selection by a user, each electricity option identifying attributes associated with the electricity used to process hydrogen fuel and determining an amount of funds to be transferred to an electricity provider based on the amount of purchased hydrogen fuel and the selected electricity option.

### CROSS-REFERENCE TO RELATED PATENT APPLICATIONS

This patent application claims the benefit of U.S. Provisional Patent Application Nos. 60/889,677, 60/889,688, 60/889,699, and 60/889,695, filed Feb. 13, 2007, the teachings and disclosure of which are hereby incorporated in their entireties by reference thereto.

### BACKGROUND

In some cases, hydrogen fuel is made by applying an electric current to water so that the hydrogen molecules are separated from the oxygen molecules. Electricity can be generated using a variety of different processing methods, with some methods being environmentally friendly while other methods, while being more cost effective, may not be as environmentally friendly.

### BRIEF DESCRIPTION OF THE DRAWINGS

FIG. 1 illustrates an embodiment of an energy financial reconciliation system;

FIG. 2 illustrates an embodiment of an energy financial management device for the energy financial reconciliation system of FIG. 1;

FIG. 3 is an embodiment of a graphical user interface (GUI) for the energy financial reconciliation system of FIGS. 1 and 2; and

FIG. 4 depicts a flow chart of an embodiment of an energy financial reconciliation method.

### DETAILED DESCRIPTION OF THE DRAWINGS

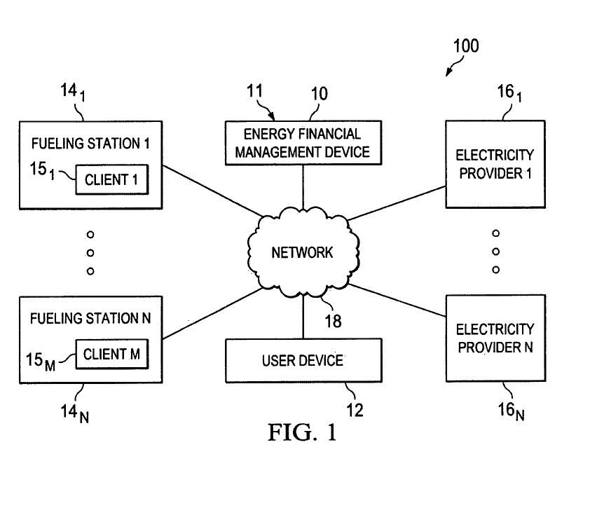

FIG. 1 illustrates an embodiment of an energy financial reconciliation system 100. Energy financial reconciliation system 100 is a financial system that determines the amount of funds to be distributed to a particular electricity provider based on an electricity option selected by a user and an amount of electricity used to generate the hydrogen fuel purchased by the user. An “electricity option,” as used herein, is a particular attribute associated with the electricity used to generate hydrogen fuel (e.g., a method of generating the electricity, an identity of the provider of the electricity, a charitable organization that the electricity provider is associated, cost of generated electricity, etc.).

In FIG. 1, system 100 comprises an energy financial management device 10, a user device 12, fueling stations 141 through 14N, electricity providers 161 through 16N, and network 18. In FIG. 1, all electronic devices of system 100 are connected and/or coupled together via network 18. It should be understood that network 18 may be any type of wired and/or wireless network communications system, including, but not limited to, a land area network (LAN), a wide area network (WAN), a personal area network (PAN), and the Internet. Furthermore, in FIG. 1, all electronic devices of system 100 may comprise any type of portable or non-portable electronic device including, but not limited to, a server, a desktop computer, a laptop computer, a notebook computer, a tablet computer, a personal digital assistant (PDA), a cellular phone or any other type of wired and/or wireless electronic device. It should further be understood that system 10 is not limited to the illustrated configuration and may comprise a plurality of energy financial management devices 10 and user devices 12.

In FIG. 1, energy financial management device 10 is configured to manage and/or reconcile the amount of funds to be distributed to various electricity providers (e.g., electricity providers 161 through 16N) based on the electricity option selected by and purchased by a user. In some embodiments, energy financial management device 10 comprises a server 11 used to centrally manage the financial aspects of energy financial reconciliation system 100. User device 12 is configured to enable a user to interface with energy financial management device 10. In some embodiments, user device 12 comprises a user interface (e.g., a graphical user interface (GUI), etc.), configured to enable the user to identify and/or select a particular electricity option presented and/or offered by energy financial management device 10.

In FIG. 1, fueling stations 141 through 14N are locations where a user may purchase and/or otherwise acquire hydrogen fuel for use in an automobile and/or other hydrogen-powered apparatus. In some embodiments, fueling stations 141 through 14N processes and/or generates hydrogen fuel using a particular electricity option provided by an electricity provider (e.g., electricity providers 161 through 16N). In this embodiment, hydrogen fuel is generated by transmitting an electric current through water. The power of the electric current separates the hydrogen molecules from the oxygen molecules in the water. The separated hydrogen molecules are then processed and/or transformed into a hydrogen fuel. It should be understood, however, that aspects of this invention are not limited to hydrogen fuel and may be applied to other energy or combustible sources (e.g., compressed air, etc.) and any apparatuses configured to use the other energy or combustible sources.

In FIG. 1, fueling stations 141 through 14N each comprise respective clients 151 through 15M. Clients 151 through 15M are electronic devices configured to interface with energy financial management device 10. In some embodiments, clients 151 through 15M are coupled to a filling station (e.g., a hydrogen fuel pump, etc.) and provide a user interface for a user to select a hydrogen fuel generated using a particular electricity option. In some embodiments, clients 151 through 15M also enable corresponding fueling stations 141 through 14N to manage and/or configure the electricity options which a user can purchase at each of fueling stations 141 through 14N. In some embodiments, a user pre-purchases and/or pre-selects a particular electricity option using a remote device (e.g., user device 12). In this embodiment, clients 151 through 15M presents the pre-purchased and/or pre-selected electricity option to a user at respective fueling stations 141 through 14N upon authentication of the user's identity. Furthermore, in some embodiments, clients 151 through 15M transmits data and/or information to energy financial management device 10 (e.g., the amount of hydrogen fuel generated using a particular electricity option) to enable energy financial management device 10 to reconcile the funds to be distributed.

In FIG. 1, electricity providers 161 through 16N provides, manufactures, and/or generates electricity for one or more of fueling stations 141 through 14N for use by fueling stations 141 through 14N to generate and/or produce hydrogen fuel. In some embodiments, electricity providers 161 through 16N generates electricity using a currently known or later developed processing method (e.g., fossil fuel, low carbon fossil fuel, coal, natural gas, nuclear power, renewable energy, wind power, etc.). It should be understood, however, that hydrogen fuel can be generated and/or produced using electricity generated by any processing method. The generated hydrogen fuel can be used with any automobile and/or other hydrogen-powered apparatus. It should also be understood that fueling stations 141 through 14N can receive electricity generated by any of electricity providers 161 through 16N. The received electricity can be generated using any processing method.

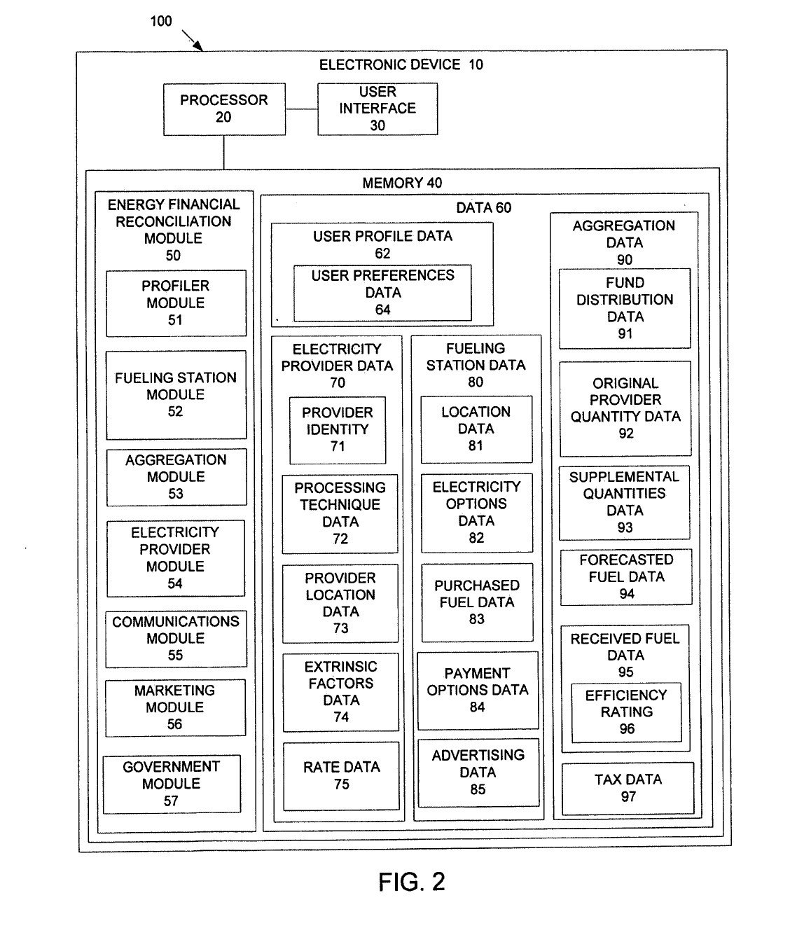

FIG. 2 illustrates an embodiment of energy financial management device 10 for system 100 of FIG. 1. In FIG. 2, energy financial management device 12 comprises a processor 20, a user interface 30 and a memory 40. Components of energy financial management device 12 may comprise hardware, software, firmware, and/or any combination thereof. It should be understood that any portion of the components of energy financial management device 12 may be included in another device within system 100. For example, portions of memory 40 may be included in user device 12 and/or any one of clients 151 through client 15M of fueling stations 141 through 14N.

In FIG. 2, memory 40 comprises an energy financial reconciliation module 50 and data 60. In the illustrated embodiment, energy financial reconciliation module 50 is stored in memory 40 so as to be accessible and executable by processor 20. However, it should be understood that energy financial reconciliation module 50 may be otherwise located (e.g., remotely). Energy financial reconciliation module 50 is configured to manage and/or identify the distribution of funds to particular electricity providers (e.g., electricity providers 161 through 16N of FIG. 1) based on a user's preferences. The fueling station (e.g., fueling stations 141 through 14N of FIG. 1) provides and/or sells the hydrogen fuel to a user and/or consumer for use by the user and/or consumer.

In FIG. 2, energy financial reconciliation module 50 comprises a profiler module 51, a fuel station module 52, an aggregation module 53, an electricity provider module 54, a communication module 55, a marketing module 56, and a government module 57. Profiler module 51 is configured to enable a user to select which electricity provider to fund based on the electricity option selected by a user. In some embodiments, profiler module 51 enables a user to select and/or identify a particular electricity option when purchasing the hydrogen fuel. The electricity option is connected to the electricity used to generate the hydrogen fuel. Therefore, in some embodiments, the selection of the electricity option determines which electricity provider the user desires to fund. In some embodiments, a user can select, configure, and/or combine one or more different electricity options, thereby selecting one or more different electricity providers to fund.

In the illustrated embodiment, fueling station module 52 is configured to enable a fueling station to manage and/or track the type of hydrogen fuel purchased at a particular fueling station. In some embodiments, a portion or all of fueling station module 52 may be included in one of clients 151 through 15M of fueling stations 141 through 14N. In some embodiments, clients 151 through 15M of fueling stations 141 through 14N communicates with electronic device 10 via network 18 (FIG. 1) to execute and/or initiate fueling station module 52 stored in energy financial management device 10. In some embodiments, fueling station module 52 identifies and/or provides at least one electricity option for purchase by a user. In some embodiments, fueling station module 52 provides a blended electricity option or an electricity option comprising electricity associated with one or more different attributes. For example, a blended electricity option may comprise electricity associated with one or more processing method (e.g., fossil fuel, low carbon fossil fuel, coal, natural gas, nuclear power, renewable energy, wind power, etc.). Thus, for example, one type of blended electricity option may comprise 25% generated by electricity as a result of low carbon fossil fuel, and 75% generated by electricity as a result of wind power. In some embodiments, fueling station module 52 provides a blended electricity option and/or non-blended electricity option. In some embodiments, fueling station module 52 enables the fueling station to create a customized blended electricity option.

In FIG. 2, aggregation module 53 aggregates and/or consolidates the hydrogen fuel and/or electricity option information from each of selected fueling stations 141 through 14N and determines the amount of funds to be distributed to a particular electricity provider (e.g., electricity providers 161 through 16N) based on the amount of and type of electricity options sold. In some embodiments, aggregation module 53 determines and/or calculates the percentage and/or portion of funds to be distributed for a blended electricity option. For example, a blended electricity option may comprise 25% generated by electricity as a result of fossil fuel and 75% electricity generated by electricity as a result of wind power. The electricity generated by fossil fuel is provided by Provider A, while the electricity generated using wind power is provided by Provider B. In this embodiment, aggregation module 53 may determine and/or calculate that 25% of the funds for that particular blended electricity option should be distributed to Provider A and 75% of to Provider B.

In some embodiments, aggregation module 53 also determines the amount of funds which an electricity provider should pay to a supplemental provider. A “supplemental provider,” as used herein, is an electricity provider used to provide electricity option because the primary electricity provider generated an inadequate supply of electricity. For example, Primary Provider A generated electricity using a wind-based processing method. The amount of electricity generated by Primary Provider A was sufficient to generate and/or produce approximately fifty gallons of gasoline equivalent (GGE) hydrogen fuel. However, Fuel Station X sold one hundred GGE of hydrogen fuel from electricity generated using a wind-based processing method. Therefore, in order to supplement the remaining fifty GGE, Primary Provider A purchased electricity generated using a wind-based processing method from Supplemental Provider 1. Thus, in this embodiment, aggregation module 53 determines and/or calculates the funds to be distributed to the primary as well as any supplemental provider(s).

In the illustrated embodiment, electricity provider module 54 is configured to consolidate and/or manage the attributes associated with the electricity provided by each of the electricity providers. In some embodiments, a portion or all of electricity module 54 may be included in electricity providers 161 through 16N. In some embodiments, electricity providers 161 through 16N communicates with electronic device 10 via network 18 to execute and/or initiate electricity provider module 54 stored in energy financial management device 10. Electricity provider module 54 associates the electricity generated by electricity providers 161 through 16N with a particular attribute to form one or more electricity options. In some embodiments, electricity provider module 54 associates the electricity with a particular processing method. In some embodiments, electricity provider module 54 associates the electricity with the identity and/or location of the provider. In some embodiments, electricity provider module 54 associates the electricity with a charitable organization in which the electricity provider donates a portion of the collected funds.

Communications module 55 is configured to facilitate communications between energy financial management device 10 and the other devices (e.g., a user device 12, fueling stations 141 through 14N, electricity providers 161 through 16N, etc.) in system 100. In some embodiments, communications module 55 provides secure and/or encoded messaging capabilities across network 18. Marketing module 56 is configured to manage and/or apply various advertising and marketing campaigns for each of electricity providers 161 through 16N and/or fueling stations 141 through 14N. For example, marketing module 56 enables electricity providers 161 through 16N and/or fueling stations 141 through 14N to transfer a portion of the funds received to a non-profit and/or charitable organization (e.g., natural disaster relief fund, domestic violence, breast cancer awareness, etc.). Government module 57 is configured to calculate and/or accordingly transfer any taxable funds associated and/or applied to each of the electricity options.

Data 60 comprises user profile data 62, electricity provider data 70, fueling station data 80, and aggregation data 90. Data 60 may be stored in any format, including, but not limited to, a table, a relational database, a file, and an eXtensible Markup Language (XML) database. User profile data 62 identifies the selected blended and non-blended electricity options for a particular user and stores the selections as user preferences data 64. In some embodiments, user preferences data 64 comprises a listing of favorite non-blended and/or blended electricity options for a particular user. In some embodiments, user preferences data 64 comprises a listing of the most cost effective electricity options.

Electricity provider data 70 comprises data and/or information for the various electricity providers (e.g., electricity providers 161 through 16N) and the attributes associated with the electricity provided by each of electricity providers 161 through 16N. In FIG. 2, each of the components of electricity provider data 70 represents an attribute of the electricity provided by electricity providers 161 through 16N. Thus, the attributes when associated with the electricity provided by electricity providers 161 through 16N form one or more electricity option(s). In FIG. 2, electricity provider data 70 comprises provider identity 71, processing technique data 72, provider location data 73, extrinsic factors data 74, and rate data 75. Provider identity 71 is the name (or other type of identity designation) for electricity providers 161 through 16N. In some embodiments, provider identity 71 may comprise a listing of both the primary fuel provider and the supplemental electricity provider(s) used by the primary electricity provider for a particular electricity option. Processing technique data 72 identifies the method of processing used by electricity providers 161 through 16N to generate the electricity. For example, processing techniques may include, but are not limited to, coal technology, natural gas technology, nuclear technology, and renewable and/or other type of environmentally based technology (e.g., wind power, solar power, etc.). In FIG. 2, provider location 73 identifies the location of each of electricity providers 161 through 16N. Provider location 73 can be a general description such as a regional location and/or be specific to a city which identifies source of the generation of the electricity. Extrinsic factors data 74 comprises any information regarding attributes not directly managed and/or associated with electricity providers 161 through 16N. For example, extrinsic factors data 74 may comprise advertisements and/or information regarding non-profit and/or charitable organizations to which respective electricity providers 161 through 16N supports. Rate data 75 comprises the price and/or cost of electricity comprising a particular attribute and provided one of electricity providers 161 through 1 6N. In some embodiments, rate data 75 comprises rate information identifying different rates for electricity usage during peak and off-peak times.

Fueling station data 80 comprises data associated with one or more of fueling stations 141 through 14N. In FIG. 2, fueling station data 80 comprises location data 81, electricity options data 82, purchased fuel data 83, payment options data 84 and advertising data 85. Location data 81 comprises geographic information for one of fueling stations 141 through 14N (e.g., address, etc.). Electricity options data 82 identifies the electricity options available to be presented by fueling stations 141 through 14N. In some embodiments, electricity options data 82 comprises a portion or all of the electricity options formed from electricity provider data 70. In some embodiments, a portion of the electricity options are presented and/or displayed on clients 151 through 15M (FIG. 1) for selection by a user. In some embodiments, fueling stations 141 through 14N creates and/or blends their own electricity option(s) and stores the blended electricity option(s) as electricity options data 82. In some embodiments, electricity options data 82 is a combination of the electricity options selected by a user in user preferences data 64 and the electricity options selected by respective fueling stations 141 through 14N. In FIG. 2, purchased fuel data 83 identifies the amount of hydrogen fuel dispensed and, in some embodiments, the selected electricity option. In some embodiments, the data stored as purchased fuel data 83 is used to determine the portion of funds distributed to a specific electricity provider based on the electricity option selected and purchased by a user. Payment options data 84 comprises data associated with processing and managing payment of purchased fuel at a particular fueling station. In some embodiments, a user remotely pre-purchases (e.g., using user device 12 of FIG. 1) a set amount of a particular electricity option. The pre-purchased amount may be stored in user preferences data 64 and transferred for temporary storage as payment options data 84 and presented to a user upon authentication of the user at one of fueling stations 141 through 14N. Advertising data 85 comprises the advertisements and/or marketing material to be presented to user when the user is interfacing with fueling station module 52 at one of fueling stations 141 through 14N.

Aggregation data 90 identifies and/or manages the supply chain and/or the distribution of funds between fueling stations 141 through 14N and electricity providers 161 through 16N. In FIG. 2, aggregation data 90 comprises fund distribution data 91, primary provider quantities data 92, supplemental quantities data 93, forecast fuel data 94, received fuel data 95, and tax data 97. Fund distribution data 91 comprises the calculated and/or determined amount of funds to be distributed to each of the electricity providers 161 through 16N based on purchased fuel data 83 for each of fueling stations 141 through 14N. In FIG. 1, primary provider quantities data 92 identifies the amount of electricity generated by each of the primary electricity providers. Supplemental quantities data 93 identifies the amount of electricity allocated to a particular fueling station by a supplemental provider, because, for example, the electricity provided by a primary provider was insufficient to meet a selected electricity option.

Forecast fuel data 94 indicates a forecast for the hydrogen fuel consumption for the various electricity options for one or more fueling stations 141 through 14N, thereby identifying the required amount of electricity and the associated attribute for the electricity from each of electricity providers 161 through 16N. Thus, in some embodiments, forecast fuel data 94 identifies which electricity option, or how much hydrogen fuel corresponding to a particular electricity option will be provided in the future by a primary fuel source provider. In some embodiments, each of fueling stations 141 through 14N pre-order an electricity option and/or hydrogen fuel quantity formed using a particular electricity option. In some embodiments, forecast fuel data 84 comprises an efficiency rating 96 which identifies the efficiency (e.g., percent loss in transformation) with which each of fueling stations 141 through 14N uses the electricity in generating the hydrogen fuel. The efficiency rating is used to identify the amount of additional electricity may be required to generate a particular amount of hydrogen fuel from the electricity due to inefficiencies in generating the hydrogen fuel at each of fueling stations 141 through 14N. In some embodiments, forecasted fuel data 94 is an aggregation one or more of fueling stations 141 through 14N. In some embodiments, a user and/or consumer identifies the amount of a particular electricity option that the user would like to pre-purchase and/or purchase in the future. In this embodiment, received fuel data 95 is also an aggregation of a portion and/or all the data stored in purchased fuel data 83. In FIG. 2, tax data 97 identifies the reconciled amount of government taxes due for the purchased hydrogen fuel and/or electricity option.

Thus, in operation, profiler module 51 is launched and/or executed in response to a user requesting access to user profile data 62. In some embodiments, profiler module 51 authenticates and/or verifies the identity of the user requesting access (e.g., via a user name and password combination, biometric authentication, etc.). Upon authentication, profiler module 51 presents a GUI or other type of user interface component on an electronic device (e.g., user device 12 of FIG. 1). Profiler module 51 enables the user to create and/or access user profile data 62 by enabling a user to select one or more electricity options. Once profiler module 51 is initiated, electricity provider module 54 aggregates and presents electricity provider data 70 to enable a user to select one or more electricity options based on provider identity 71, processing technique data 72, provider location data 73, extrinsic factors data 74, and/or rate data 75. In some embodiments, electricity provider module 54 presents the hydrogen fuel in relationship with electricity provider data 70. For example, electricity provider module 54 may present a Hydrogen Fuel 1 generated using electricity provided by Provider A and a Hydrogen Fuel 2 generated using electricity provided by Provider B. As another example, electricity provider module 54 may present Hydrogen Fuel 3 generated using a fossil fuel processing method, and a Hydrogen Fuel 4 generated using a wind based processing method. In some embodiments, electricity provider module 54 may present only the electricity option. For example, electricity provider module 54 may present Electricity Option 1 generated by a coal-based processing method and Electricity Option 2 generated by a solar-based processing method. In some embodiments, profiler module 51 enables a user to create and/or customize their own blend of electricity options (e.g., favorite electricity option, most cost efficient electricity option, etc.). The selected electricity options are stored as user preferences data 64. In some embodiments, profiler module 51 also automatically identifies user's location based on information associated with user device 12 (FIG. 1) (e.g., IP address, etc.) in which the user is requesting access. In this embodiment, profiler module 51 can also identify and store as user preferences data 64 which of fueling stations 141 through 14N is closest in proximity to the user. In this embodiment, communications module 55 can also transmit user preferences data 64 to the identified fueling station for storage as purchased fuel data 83 and presented to a user upon authentication.

In some embodiments, fueling station module 52 is initiated and/or executed for presentation and/or display on one of clients 151 through 15M at one of fueling stations 141 through 14N. In some embodiments, fueling station module 52 requests a user to input user authentication information. Upon identification of the user, fueling station module 52 accesses user preferences data 64 for the user to identify one or more selected electricity options for the user (e.g., blended, non-blended, etc.). In some embodiments, fueling station module 52 presents and/or displays on a filling pump display the selected electricity options for purchase and/or filling by the user. In some embodiments, fueling station module 52 also presents a portion or all of the electricity options stored in electricity options data 82 for purchase and/or filing by the user. In some embodiments, instead of selecting one of the presented electricity options at the filling pump, a user can choose and/or select a completely different electricity option and/or combine the presented electricity options to create another blended electricity option. Fueling station module 52 stores the amount of hydrogen fuel dispensed and the corresponding selected electricity option as purchased fuel data 83. In some embodiments, marketing module 56 initiates and/or is executed in conjunction with fueling station module 52 to identify and present advertisement and other marketing material to particular user. In some embodiments, marketing module 56 reads advertising data 85 to determine the advertising and/or marketing information to be presented to a user while the user is operating a particular filling station.

In operation, aggregation module 53 launches and/or is executed to determine the amount of funds to be distributed to each of electricity providers 161 through 16N. Aggregation module 53 requests purchased fuel data 83 from one or more of fueling stations 141 through 14N and stores the aggregated data as received fuel data 85. Aggregation module 53 determines and/or calculates the fund distribution for each of electricity providers 161 through 16N based on the amount of hydrogen fuel purchased and the selected electricity option(s). For example, consider a hydrogen fuel option which designates and/or otherwise indicates that 20% of the purchased hydrogen fuel should fund electricity generated using a coal-based processing method, while 80% of the purchased hydrogen fuel should fund electricity generated using a nuclear based processing method. Aggregation module 53 calculates the total amount of purchased hydrogen fuel funds received and multiplies the total amount of purchased hydrogen fuel by the corresponding percentage for each electricity option and stores the calculated amount as fund distribution data 91. In some embodiments, out of the total amount of hydrogen fuel funds received, aggregation module 53 determines what portion of the funds that are to be allocated to the primary electricity provider and how much of the funds are to be distributed to a supplemental electricity provider. In some embodiments, aggregation module 53 references primary provider quantities data 92 to identify the amount of electricity having a particular attribute that was generated by a particular primary electricity provider. If the total quantity of an electricity option sold exceeds the amount of electricity generated with primary electricity provider with that particular attribute, then aggregation module 53 allocates and/or distributes the remaining portion of the purchased hydrogen fuel funds to the supplemental electricity provider. In some embodiments, aggregation module 53 references supplemental quantities data 93 to identify the amount of a particular electricity option was generated and/or provided by a supplemental electricity provider. In some embodiments, aggregation module 53 transmits corresponding fund distribution data 91 to respective electricity providers 161 through 16N. In some embodiments, in operation, government module 57 is initiated and/or executed to determine the amount of taxes to be applied and distributed to the government. In this embodiment, government module 57 references tax data 97 to identify the proportion and/or percentage of taxes to be applied to particular hydrogen fuel options and/or electricity options. In some embodiments, government module 57 reports the calculated tax amounts to the respective government entity.

It should be understood, however, that any of the electricity options formed from electricity provider data 70 may be presented at any of fueling stations 141 through 14N. Energy financial reconciliation module 50 enables a user to identify and/or specify a particular electricity provider to fund based on the electricity option selected by the user. Energy financial reconciliation module 50 reconciles the funds based on the selected electricity option which the user chooses. Thus, a user can purchase a hydrogen fuel and select an electricity option whether or not the hydrogen fuel actually used the selected electricity option to generate the hydrogen fuel. The properties of the hydrogen fuel itself has not changed, simply the attributes associated with the electricity has changed. Thus, in some embodiments, the demand for a particular electricity option may exceed the amount of electricity generated by both a primary provider and a supplemental provider. In this embodiment, energy financial reconciliation module 50 can request that the electricity provider generate more electricity in the future that matches the attributes of the electricity to compensate for the shortfall. Instead, in some embodiments, energy financial reconciliation module 50 may request that the electricity provider financially supplement the difference in the production cost to compensate for the shortfall in productions.

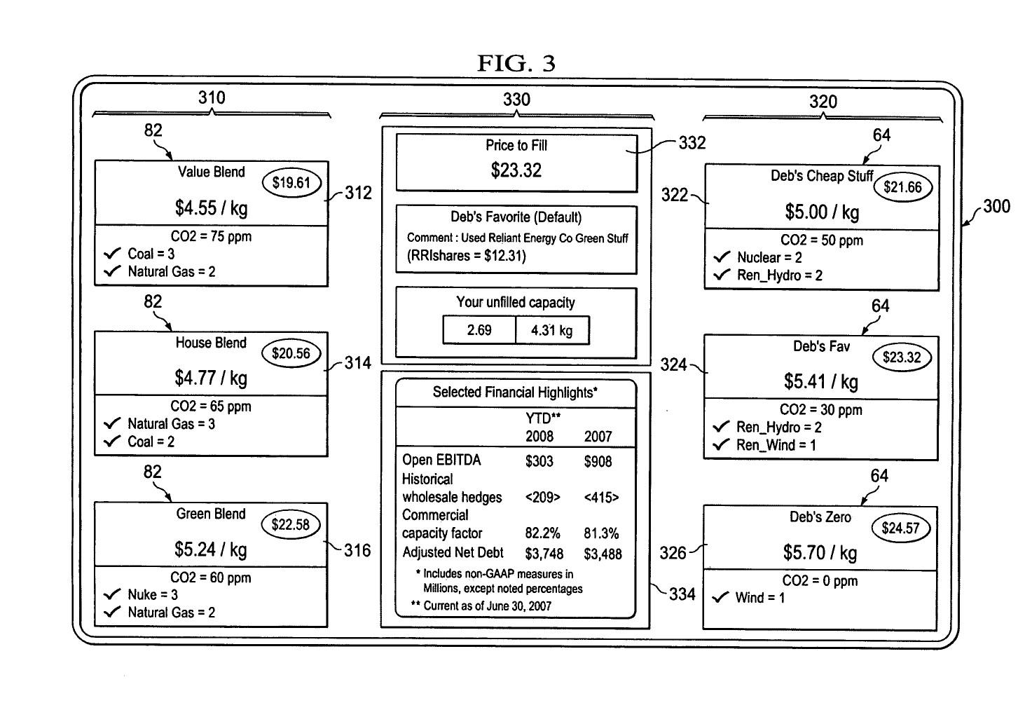

FIG. 3 is an embodiment of a GUI for system 100. In some embodiments, GUI 300 is an example image displayed and/or presented on one of Clients 151 through 15M (FIG. 1) for one of fueling stations 141 through 14N (FIG. 1). In some embodiments, some and/or substantially all of GUI 300 is also presented on user device 12 (FIG. 1) when profiler module 51 is executed and/or initiated. In FIG. 3, GUI 300 comprises a fueling station portion 310, a user preferences portion 320, and a miscellaneous information section 330. In FIG. 3, fueling station portion 310 illustrates the electricity options selected and/or configured by the fueling station presenting GUI 300. In FIG. 3, fueling station portion 310 comprises three blended electricity options 82: a value blend 312, a house blend 314, and a green blend 316. Each electricity option 82 is a mixture and/or combination of one or more electricity options combined from electricity provider data 72 (FIG. 2). For example, value blend 312 is electricity generated using a fossil fuel having 75 parts per million (ppm) of carbon dioxide (CO2). In generating the electricity, three-fifths (or 60%) of the funds are allocated to electricity generated using a coal-based processing method, and two-fifths (or 40%) of the funds are allocated to electricity generated using a natural gas based processing method. It should be understood, however, that different electricity providers (e.g., electricity providers 161 through 16N) can provide the electricity options to form the example blends. As another example, for house blend 314, electricity is generated from a fossil fuel having 65 ppm of CO2. In generating the electricity, three-fifths (or 60%) of the funds are allocated to electricity generated using a natural gas based processing method, while two-fifths (or 40%) are allocated to electricity generated using a coal-based processing method. For green blend 316, electricity is generated from a fossil fuel having 60 ppm of CO2, with three-fifths (or 60%) of the funds allocated to electricity using a nuclear (“Nuke”) based processing method and two-fifths (or 40%) of the funds allocated to electricity using a natural gas processing method.

User-specific information 320 illustrates user preferences data 64 for a user named “Deb.” In some embodiments, user-specific information 320 presents information stored as user preferences data 64 (FIG. 2) created using profiler module 51 (FIG. 2) and electricity provider module 54 (FIG. 1). In FIG. 3, user-specific information 320 comprises Deb's Cheap Stuff 322, Deb's Favorite (“Fav”) 324, and Deb's Zero 326. In the illustrated embodiment, Deb's Cheap Stuff 322 comprises electricity generated from a fossil fuel having 60 ppm of CO2. In generating the electricity, two-fourths (or 50%) of the funds are allocated to electricity generated using a natural gas based processing method, while the other two-fourths (or 50%) of the funds are allocated to electricity generated using a Renewable Hydrogen (“Ren Hydro”) based processing method. In FIG. 3, Deb's Fav blend 324 comprises electricity generated from a fossil fuel having 30 ppm of CO2. In generating the electricity, two-thirds (or 66%) of the funds are allocated to electricity generated using a Ren_Hydro, while the other one-third (or 33%) are allocated to electricity generated using a Renewable-Wind (“Ren Wind”) based processing method. In the illustrated embodiment, Deb's Zero blend 326 comprises electricity generated from a fossil fuel having zero ppm of CO2. The electricity is generated solely by a Ren_Wind based processing method.

It should be understood, however, that, in some embodiments, the user (e.g., Deb) can also create and/or configure a different electricity option blend than the ones illustrated in GUI 300. For example, Deb may choose to combine value blend 312 with Deb's Fav 324 to create a new electricity option blend. In this example, aggregation module 53 (FIG. 1) can determine and/or calculate the appropriate portions and/or percentages for each electricity option included in value blend 312 and Deb's Fav 324 to determine the distribution of funds to the respective electricity provider.

In FIG. 3, miscellaneous information portion 330 presents information other than the selected electricity options for the respective fueling station and/or user. In FIG. 3, miscellaneous information portion 330 comprises an automobile properties section 332 and a marketing section 334. In the illustrated embodiment, the automobile properties section 332 comprises information on the total cost to fill Deb's hydrogen powered automobile, identifies Deb's Favorite electricity option, and the amount of unfilled capacity in Deb's automobile. In some embodiments, GUI 300 presents advertising and/or marketing material in marketing section 334. In FIG. 3, marketing section 334 comprises investment and/or financial information for a particular investment. It should be understood, however, that the information provided in GUI 300 may comprise more and/or different information than illustrated.

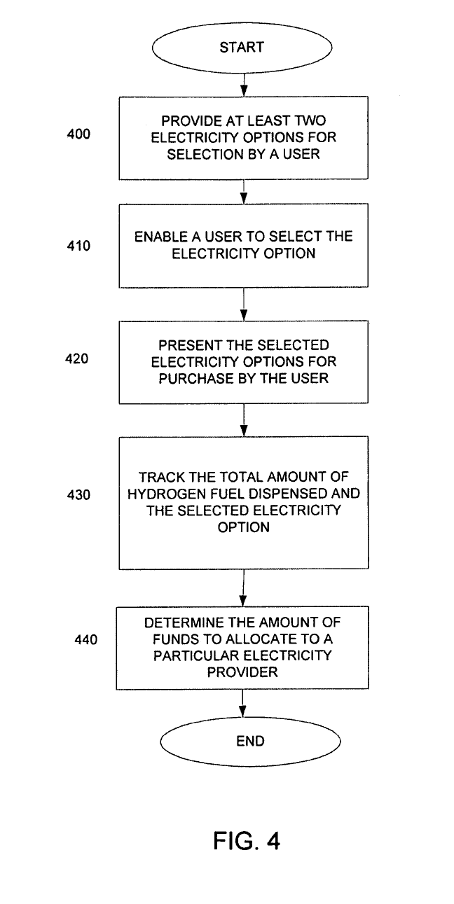

FIG. 4 depicts a flow chart of an embodiment of an energy financial reconciliation method. The method begins with block 300 with energy financial reconciliation module 50 providing at least two electricity options for selection by a user. In some embodiments, financial reconciliation module 50 presents the electricity options on user device 12 (FIG. 1) for a user to create and/or modify user preferences data 64 for the user. Energy financial reconciliation module 50 then enables the user to select the electricity options based on electricity provider data 70 (block 410). Energy financial reconciliation module 50 then stores the selected electricity options as user preferences data 64 and subsequently presents the stored electricity options for purchase by a user at one of fueling stations 141 through 14 (block 420). Energy financial reconciliation module 50 then tracks the total amount of hydrogen fuel dispensed and the selected electricity option (block 430). In some embodiments, energy financial reconciliation module 50 stores the amount of hydrogen fuel dispensed and the selected electricity option as purchased fuel data 83 for each of fueling stations 141 through 14 and aggregates the total purchased fuel data 83 from one or more of fueling stations 141 through 14 as received fuel data 95. Energy financial reconciliation module 50 then determines and/or calculates the amount of funds to distribute and/or allocate to a particular electricity provider (electricity providers 161 through 16N) based on received fuel data 95, primary provider quantities data 92, and supplemental quantities data 93 (block 440). The calculated funds are stored as fund distribution data 91, with the method terminating thereafter.

The illustrative embodiments may be implemented in software and can be adapted to run on different platforms and operating systems. In particular, functions implemented by energy financial reconciliation system 100, for example, may be provided by an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium.

Embodiments of energy financial reconciliation system 100 enable a user to identify one of electricity providers 161 through 16N to fund based on one or attributes associated with the electricity used to generate the electricity provided by electricity providers 161 through 1 6N. In some embodiments, a user identifies a particular electricity option based on the identity of the electricity provider. In some embodiments, a user identifies a particular option based on the method of generating the electricity. In some embodiments, a user identifies a particular option based on the cost of generating the electricity and subsequently the hydrogen fuel. Therefore, in this manner, users are able to select the electricity option based on personal preferences (e.g., an environmentally friendly generated electricity, a cost effective generated electricity, etc.).

What is claimed is:

1. An energy financial reconciliation method, comprising:
displaying at least two electricity options for selection by a user, each electricity option identifying attributes associated with the electricity used to process hydrogen fuel; and
determining an amount of funds to be transferred to an electricity provider based on the amount of purchased hydrogen fuel and the selected electricity option.

2. The method of claim 1, further comprising enabling a user to select the electricity option at a hydrogen fueling station.

3. The method of claim 1, further comprising enabling a user to remotely select the electricity option on a user device networked to a hydrogen fueling station.

4. The method of claim 1, wherein the attribute identifies a method for generating the electricity.

5. The method of claim 1, wherein the attribute identifies a cost for generating the electricity.

6. The method of claim 1, wherein the attribute identifies the identity of the electricity provider.

7. The method of claim 1, further comprising enabling a user to create an electricity blend comprising a combination of electricity options.

8. The method of claim 1, further comprising tracking the amount of purchased hydrogen fuel in order to determine a portion of funds to be distributed to the electricity provider.

9. The method of claim 1, further comprising tracking the amount of purchased hydrogen fuel in order to identify a portion of funds to be distributed to a primary electricity provider and a supplemental electricity provider.

10. An energy financial reconciliation system, comprising:
an energy financial reconciliation module configured to display at least two electricity options for selection by a user, wherein each electricity option identifies an attribute associated with the electricity used to process hydrogen fuel, and wherein the energy financial reconciliation module determines an amount of funds to be transferred to an electricity provider based on an amount of purchased hydrogen fuel and the selected electricity option.

11. The system of claim 10, wherein the energy financial reconciliation module is configured to enable a user to select the electricity option at a hydrogen fueling station.

12. The system of claim 10, further comprising a user device networked to the energy financial reconciliation module, the user device enabling a user to remotely select the electricity option.

13. The system of claim 10, wherein the wherein the attribute identifies a method for generating the electricity.

14. The system of claim 10, wherein the attribute identifies a cost for generating the electricity.

15. The system of claim 10, wherein the attribute identifies the identity of the electricity provider.

16. The system of claim 10, wherein the energy financial reconciliation module is configured to enable a user to create an electricity blend comprising a combination of electricity options.

17. The system of claim 10, wherein the energy financial reconciliation module is configured to track the amount of purchased hydrogen fuel to identify a portion of funds to be distributed to the electricity provider.

18. The system of claim 10, wherein the energy financial reconciliation module is configured to track the amount of purchased hydrogen fuel to identify a portion of funds to be distributed to a primary electricity provider and a supplemental electricity provider.

19. An energy financial reconciliation system, comprising:
a profiler module enabling a user to create a blended electronic option based on an attribute associated with electricity used to process hydrogen fuel; and
an aggregation module reconciling a portion of funds to be transferred to an electricity provider supplying the electricity for generating the hydrogen fuel.

20. The system of claim 19, wherein the attribute comprises one of a method of generating the electricity, an organization with which the electricity provider is associated, an identity of the electricity provider, and a cost of the electricity used to process the hydrogen fuel.
